(19) United States
(12) Patent Application Publication
(10) Pub. No.: US 2015/0030925 A1
(43) Pub. Date: Jan. 29, 2015

(54) POSITIVE ELECTRODE MATERIAL

(71) Applicant: Hitachi, Ltd., Tokyo (JP)

(72) Inventors: Hiroaki Konishi, Tokyo (JP); Akira Gunji, Tokyo (JP); Xiaoliang Feng, Tokyo (JP)

(73) Assignee: HITACHI, LTD., Tokyo (JP)

(21) Appl. No.: 14/379,978

(22) PCT Filed: Jan. 21, 2013
(86) PCT No.: PCT/JP2013/051024

§ 371 Date: Aug. 20, 2014

(30) Foreign Application Priority Data
Feb. 27, 2012 (JP) 2012-040074

(51) Int. Cl. H01M 4/505; H01M 4/485; H01M 10/0525; H01M 4/525

(52) U.S. Cl. CPC H01M 4/505; H01M 4/525; H01M 4/485; H01M 10/0525; H01M 2004/028
USPC 429/223; 252/182.1

(57) ABSTRACT

A positive electrode material is disclosed that can attain a lithium-ion secondary battery having a high capacity and a high security. The positive electrode material provides a positive electrode having a high capacity and a high security by using a positive electrode active material represented by the following composition formula;

xLi₂MnO₃-(1-x)LiNiₐMn_{b}Co_{c}M_{d}O₂

(0.3≦x≦0.7, 0.33≦a≦0.5, 0≦b≦0.5, 0≦c≦0.33, 0.01≦d≦0.06).

### TECHNICAL FIELD

The present invention relates to a positive electrode material for a lithium-ion secondary battery.

### BACKGROUND ART

In recent years, expectations are concentrated on an electric automobile requiring less energy for running with concern over the prevention of global warming and the exhaustion of fossil fuel, but the related technologies have the following technical problems and are not popularized yet.

A problem of an electric automobile is that the energy density of a battery for drive is low and the mileage on a single charge is small. Consequently, an inexpensive secondary battery having a high energy density is needed.

A lithium-ion secondary battery is expected to be applied to an electric automobile and an electric power storage system since it has a high energy density per weight in comparison with the secondary batteries such as a nickel hydride battery and a lead battery. However, a higher energy density is necessary in order to respond to the need of an electric automobile and the energy density of a positive electrode and a negative electrode has to be increased in order to obtain a high energy battery.

As a positive electrode active material of a high energy density, an Li₂MO₃-LiM′O₂ solid solution is expected. Here, M is at least one element selected from the group of Mn, Ti, and Zr and M′ is at least one element selected from the group of Ni, Co, Mn, Fe, Ti, Zr, Al, Mg, Cr, and V. An Li₂MO₃—LiM′O₂ solid solution is hereunder referred to as a solid solution positive electrode active material.

Patent Literature 1 describes a positive electrode material having particles each of which has a concentration gradient of LiMO₂ and Li₂MnO₃ from the center toward the outer surface of the particle by allocating LiMO₂ having a low resistance abundantly on the surface side of the particle and Li₂MnO₃ abundantly in the center of the particle in order to obtain a high discharge capacity even at a high rate.

### CITATION LIST

### Patent Literature

Patent Literature 1: Japanese Unexamined Patent Publication No. 2011-134670

### SUMMARY OF INVENTION

### Technical Problem

In the configuration of Patent Literature 1 however, thermal stability is not taken into consideration and particularly it has been concerned that thermal stability deteriorates since a particle is configured so that the concentration of Li₂MnO₃ may come to be higher than the concentration of LiMO₂ toward the center of the particle.

The present invention is established in view of the above situation and an object thereof is to provide a positive electrode material for a lithium-ion secondary battery having a high thermal stability.

### Solution to Problem

In order to attain the above object, a positive electrode material for a lithium-ion secondary battery according to the present invention is characterized by including a positive electrode active material represented by xLi₂MnO₃-(1-x)LiNiₐMn_{b}Co_{c}M_{d}O₂ (0.3≦x≦0.7, 0.33≦a≦0.5, 0≦b≦0.5, 0≦c≦0.33, 0.01≦d≦0.06), where M is at least one element selected from the group of V and Mo.

### Advantageous Effects of Invention

The present invention makes it possible to: obtain a positive electrode material having a high thermal stability; and materialize a high-security lithium-ion secondary battery. Here, problems, configurations, and effects other than those described above will be obvious through the following explanations of embodiments.

### BRIEF DESCRIPTION OF DRAWINGS

FIG. 1 is a graph showing oxygen evolution behavior when the positive electrode active materials of example 1 and comparative example 1 are heated in charging states respectively.

FIG. 2 is a partial sectional view showing the structure of a cylindrical battery.

### DESCRIPTION OF EMBODIMENTS

When a lithium-ion secondary battery is adopted in an electric automobile, both a high capacity and a high security are required simultaneously. The characteristics of the lithium-ion secondary battery are closely related to the nature of a positive electrode material.

A positive electrode active material represented by the composition formula xLi₂MnO₃-(1-x)LiMO₂ (M represents a transition metal): has an advantage that a high capacity can be obtained in comparison with a conventional stratified-type positive electrode active material LiMO₂ (M represents a transition metal); but has a drawback of a poor thermal stability in a charging state. Consequently, when the temperature of a battery rises by an internal short-circuit or the like, there is concern that oxygen discharged from the interior of a positive electrode active material reacts with an electrolyte at a relatively low temperature, a large exothermic reaction occurs, and the battery ignites or bursts by the exothermic reaction.

A positive electrode material according to the present embodiment: solves the problems; and is characterized by including a positive electrode active material represented by the composition formula xLi₂MnO₃-(1-x)LiNiₐMn_{b}Co_{c}M_{d}O₂ (0.3≦x≦0.7, 0.33≦a≦0.5, 0≦b≦0.5, 0≦c≦0.33, 0.01≦d≦0.06), where M is at least one element selected from the group of V and Mo.

A positive electrode material according to the present embodiment can improve thermal stability in a charging state by adding V or Mo to a solid solution positive electrode active material and adopting the aforementioned conditions. A positive electrode material according to the present embodiment can reduce a calorific value substantially when it is heated together with an electrolyte in comparison with a material to which V or Mo is not added. Consequently, it is possible to: reduce the likelihood of causing ignition or burst when a battery temperature rises; and improve security. Consequently, it is possible to provide a positive electrode material for a lithium-ion secondary battery and a lithium-ion secondary battery, those reducing the likelihood of causing ignition or burst when a battery temperature rises and improving security.

A positive electrode active material in a positive electrode material according to the present embodiment is explained here. In the composition formula of a positive electrode active material, a value of x representing a ratio of Li₂MnO₃ to LiNiₐMn_{b}Co_{c}M_{d}O₂ is not less than 0.3 to not more than 0.7 (0.3≦x≦0.7). If a value of x is less than 0.3 (x<0.3), the capacity is comparable to that of a stratified-type positive electrode and a high capacity that is an advantage of a stratified solid solution is not obtained. If a value of x is more than 0.7 (x>0.7), the ratio of electrically inert Li₂MnO₃ increases, the resistance of the positive electrode active material increases, and the capacity decreases.

An Ni content (atomic weight ratio) in a positive electrode active material is represented by “a” in the composition formula and is in the range of 0.33≦a≦0.5. If a<0.33 stands, the content of Ni contributing mainly to charge and discharge reaction reduces and the capacity decreases. If a>0.5 stands, thermal stability deteriorates.

An Mn content (atomic weight ratio) in a positive electrode active material is represented by b in the composition formula and is in the range of 0≦b≦0.5. If b>0.5 stands, the content of Ni involved in charge and discharge reduces and the capacity decreases.

A Co content (atomic weight ratio) in a positive electrode active material is represented by c in the composition formula and is in the range of 0≦c≦0.33. If c>0.33 stands, the content of Ni involved in charge and discharge reduces and hence the capacity decreases.

An M content (atomic weight ratio) in a positive electrode active material is represented by d in the composition formula and is in the range of 0.01≦d≦0.06. If d<0.01 stands, thermal stability in a charging state cannot be improved. If d>0.06 stands, a crystal structure is destabilized and the capacity decreases.

The concentrations of Li₂MnO₃ and LiNiₐMn_{b}Co_{c}M_{d}O₂ are homogeneous in the particles of a positive electrode active material. V and Mo in each of the particles of a positive electrode active material intermix overall uniformly without unevenness on both the surface side and the center side of the particle and the existence ratio thereof falls within the range of 0.8 to 1.2 (the range of 1±0.2). Consequently, the whole of the particles can be involved in electrochemical reaction in a well-balanced manner and high battery characteristics can be obtained. If an existence ratio deviates from the range of 0.8 to 1.2, unevenness increases, a region contributing to electrochemical reaction reduces, and battery characteristics deteriorate.

A synthesis method of positive electrode active materials used in example and comparative example according to the present invention, the manufacturing of a trial battery, and the measurement of battery characteristics and thermal stability are described hereunder.

### (Manufacturing of Positive Electrode Active Material)

A precursor is obtained by applying spray drying with a spray drying device after lithium acetate, nickel acetate, manganese acetate, cobalt acetate, vanadium oxide, molybdic acid, and the like are dissolved in purified water. A lithium transition metal oxide is obtained by baking the obtained precursor at 500° C. for 12 hours in the atmosphere. The obtained lithium transition metal oxide is baked at 800° C. to 1,000° C. for 12 hours in the atmosphere after pelletized. The baked pellets are pulverized in an agate mortar, classified with a sieve of 45 μm, and turned into a positive electrode active material.

Meanwhile, only in comparative example 6, vanadium oxide is not included at the beginning, the other substances excluding vanadium oxide are baked at 500° C. for 12 hours, successively vanadium oxide is added in an agate mortar, successively the substances including vanadium oxide is pelletized and then baked at 800° C. to 1,000° C. for 12 hours in the atmosphere. The baked pellets are pulverized in an agate mortar, classified with a sieve of 45 μm, and turned into a positive electrode active material.

The compositions of the manufactured positive electrode active materials and the positive electrode active materials used in example and comparative example are shown in Table 1, respectively.

TABLE 1

| | | x | a(Ni) | b(Mn) | c(Co) | d(V, Mo) |
|---|---|---|---|---|---|---|
| Example 1 | Positive electrode | 0.5 | 0.33 | 0.33 | 0.29 | 0.04(V) |
| | active material 1 | | | | | |
| Example 2 | Positive electrode | 0.5 | 0.33 | 0.33 | 0.32 | 0.01(V) |
| | active material 2 | | | | | |
| Example 3 | Positive electrode | 0.5 | 0.33 | 0.33 | 0.31 | 0.02(V) |
| | active material 3 | | | | | |
| Example 4 | Positive electrode | 0.5 | 0.33 | 0.33 | 0.27 | 0.06(V) |
| | active material 4 | | | | | |
| Example 5 | Positive electrode | 0.5 | 0.33 | 0.33 | 0.31 | 0.02(Mo) |
| | active material 5 | | | | | |
| Example 6 | Positive electrode | 0.5 | 0.33 | 0.33 | 0.29 | 0.04(Mo) |
| | active material 6 | | | | | |
| Example 7 | Positive electrode | 0.5 | 0.48 | 0.48 | 0 | 0.04(V) |
| | active material 7 | | | | | |
| Example 8 | Positive electrode | 0.3 | 0.33 | 0.33 | 0.29 | 0.04(V) |
| | active material 8 | | | | | |
| Example 9 | Positive electrode | 0.7 | 0.33 | 0.33 | 0.29 | 0.04(V) |
| | active material 9 | | | | | |
| Comp. | Positive electrode | 0.5 | 0.33 | 0.33 | 0.33 | 0 |
| example 1 | active material 10 | | | | | |
| Comp. | Positive electrode | 0.5 | 0.33 | 0.33 | 0.25 | 0.08(V) |
| example 2 | active material 11 | | | | | |
| Comp. | Positive electrode | 0.5 | 0.33 | 0.33 | 0.25 | 0.08(Mo) |
| example 3 | active material 12 | | | | | |
| Comp. | Positive electrode | 0.2 | 0.33 | 0.33 | 0.29 | 0.04(V) |
| example 4 | active material 13 | | | | | |
| Comp. | Positive electrode | 0.8 | 0.33 | 0.33 | 0.29 | 0.04(V) |
| example 5 | active material 14 | | | | | |
| Comp. | Positive electrode | 0.5 | 0.33 | 0.33 | 0.29 | 0.04(V) |
| example 6 | active material 15 | | | | | |

Charge and discharge tests and differential scanning calorimetry are applied to the fifteen types of trial batteries manufactured as stated above in examples 1 to 9 and comparative (comp.) examples 1 to 6.

### (Manufacturing of Trial Battery)

Positive electrodes are manufactured by using the fifteen types of positive electrode active materials manufactured as stated above and fifteen types of trial batteries are manufactured in examples 1 to 9 and comparative examples 1 to 6.

A method for manufacturing a positive electrode is explained as follows. Positive electrode slurry (positive electrode material) is manufactured by mixing a positive electrode active material, a conductive auxiliary agent, and a binder uniformly. Then the positive electrode slurry is applied on an aluminum collector foil 20 μm in thickness and dried at 120° C., compression molding is applied by press so that the electrode density may be 2.2 g/cm³, and thus an electrode plate is obtained. Successively, the electrode plate is punched into a disc 15 mm in diameter and thus a positive electrode is manufactured.

A negative electrode is manufactured by using metal lithium. As a non-aqueous electrolyte, a substance produced by dissolving LiPF₆ of 1.0 mol/liter in a mixed solvent containing EC (ethylene carbonate) and DMC (dimethyl carbonate) at a ratio of 1:2 in volume ratio is used. Charge and discharge tests and measurement of calorific values are applied to the fifteen types of trial batteries manufactured as stated above in examples 1 to 9 and comparative examples 1 to 6.

### (Charge and Discharge Test)

A charge and discharge test is applied to a trial battery under the conditions of 0.05 C, an upper limit voltage of 4.6 V, and a lower limit voltage of 2.5 V.

### (Differential Scanning Calorimetry)

A trial battery is charged at constant current/constant voltage up to 4.6 V and successively an extracted positive electrode is cleaned by DMC. Successively, the extracted positive electrode is punched into a disc of 3.5 mm in diameter and inserted in a sample pan, an electrolyte of 1 μl (microliter) is added, and a sample is produced by applying sealing.

A calorific value when the sample is heated from room temperature to 400° C. at 5° C./min is examined.

### (Measurement of V Content on Particle Surface and in Particle Interior)

The ratio of the V contents (d) (content at 500 nm/content at 50 nm) at 50 nm and 500 nm from a particle surface is measured with an Auger spectrometer in each of example 1 and comparative example 6. Here, a distance in the depth direction used with the Auger spectrometer is obtained in SiO₂ equivalent.

A value obtained by dividing a discharge capacity obtained in each of examples 1 to 9 and comparative examples 1 to 6 by the result of comparative example 1 is shown as a discharge capacity ratio in Tables 2 to 4. Further, a value obtained by dividing a calorific value obtained in each of examples 1 to 9 and comparative examples 1 to 6 by the result of comparative example 1 is shown as a calorific value ratio in Tables 2 to 4.

TABLE 2

| | Discharge | Calorific |
|---|---|---|
| | capacity ratio | value ratio |
| Example 1 | 0.97 | 0.59 |
| Example 2 | 0.99 | 0.69 |
| Example 3 | 0.98 | 0.65 |
| Example 4 | 0.92 | 0.59 |
| Example 5 | 0.96 | 0.57 |
| Example 6 | 0.94 | 0.51 |
| Example 7 | 0.98 | 0.58 |
| Comparative | 1 | 1 |
| example 2 | | |
| Comparative | 0.87 | 0.68 |
| example 3 | | |
| Comparative | 0.83 | 0.58 |
| example 4 | | |

TABLE 3

| | Discharge | Calorific |
|---|---|---|
| | capacity ratio | value ratio |
| Example 8 | 0.92 | 0.64 |
| Example 9 | 0.9 | 0.54 |
| Comparative | 0.81 | 0.53 |
| example 4 | | |
| Comparative | 0.54 | 0.43 |
| example 5 | | |

TABLE 4

| | Discharge | Calorific | V content in particle |
|---|---|---|---|
| | capacity ratio | value ratio | (interior/surface) |
| Example 1 | 0.97 | 0.59 | 0.9 |
| Comparative | 0.96 | 0.78 | 0.02 |
| example 6 | | | |

Table 2 is explained. In examples 1 to 7, the reduction of a discharge capacity can be suppressed within 10% and a calorific value can be reduced by 30% or more in comparison with comparative example 1. This is presumably because V and Mo that can suppress heat generation are added by 1% to 6%. In comparative examples 2 and 3 in contrast, a discharge capacity reduces by 10% or more. This is presumably because V and Mo are added by 8% abundantly.

Table 3 is explained. In examples 8 and 9, the reduction of a discharge capacity can be suppressed within 10% and a calorific value can be reduced by 30% or more in comparison with comparative example 1. This is because a composition ratio (x) of Li₂MnO₃ to LiNiMnCoMO₂ falls within the range of 0.3 to 0.7. In comparative examples 4 and 5 in contrast, a discharge capacity reduces by more than 10%. In comparative example 4, the ratio of LiNiMnCoMO₂ is excessive and hence only a capacity comparable to that of a stratified-type positive electrode material can be obtained. Further, in comparative example 5, the ratio of Li₂MnO₃ that is scarcely involved in charge and discharge is excessive and hence the capacity deteriorates substantially.

Table 4 is explained. In comparative example 6, the calorific value cannot be suppressed in comparison with example 1. This is because V is unevenly distributed only on the surface of a particle and hence the stability of the structure in a charging state cannot be improved.

From the results of Tables 2 to 4, it is obvious that a positive electrode material for a lithium-ion secondary battery having a positive electrode active material represented by xLi₂MnO₃-(1-x)LiNiₐMn_{b}Co_{c}M_{d}O₂ (0.3≦x≦0.7, 0.33≦a≦0.5, 0≦b≦0.5, 0≦c≦0.33, 0.01≦d≦0.06), where M is at least one element selected from the group of V and Mo has a high capacity and a high thermal stability simultaneously.

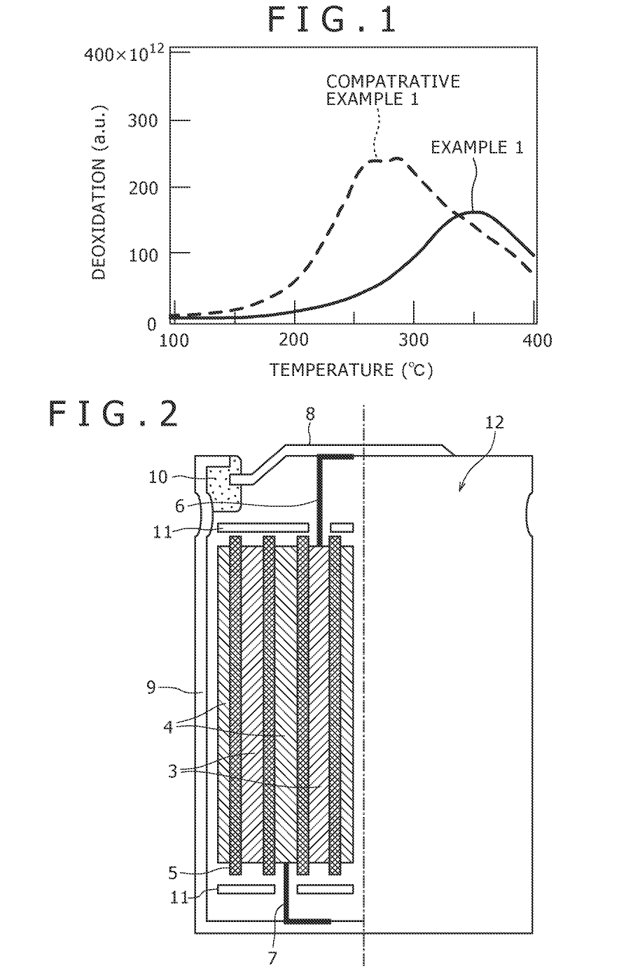

FIG. 1 is a graph showing oxygen evolution behavior when the trial batteries of example 1 and comparative example 1 are heated in charging states respectively. The horizontal axis represents a temperature and the vertical axis represents a generated oxygen quantity. As shown in FIG. 1, it is obvious that the positive electrode active material to which V is added in example 1 can reduce the generated oxygen quantity in comparison with the positive electrode active material to which V is not added in comparative example 1.

FIG. 2 is a sectional view of a substantial part schematically showing the structure of a lithium-ion secondary battery according to the present embodiment. A lithium-ion secondary battery 12 shown in FIG. 2 has an electrode group comprising a positive electrode plate 3 formed by applying a positive electrode material on both the surfaces of a collector, a negative electrode plate 4 formed by applying a negative electrode material on both the surfaces of a collector, and a separator 5. In the present embodiment, the positive electrode plate 3 and the negative electrode plate 4 are wound with the separator 5 interposed and constitute an electrode group of a wound body. The wound body is inserted into a battery can 9.

The negative electrode plate 4 is electrically connected to the battery can 9 through a negative electrode lead piece 7. An airtight lid 8 is attached to the battery can 9 through a packing 10. The positive electrode plate 3 is electrically connected to the airtight lid 8 through a positive electrode lead piece 6. The wound body is insulated by insulating plates 11.

Here, an electrode group may not be such a wound body as shown in FIG. 2 and may also be a laminated body formed by stacking positive electrode plates 3 and negative electrode plates 4 with separators 5 interposed.

By using a positive electrode manufactured by applying a positive electrode material shown in the present embodiment as a positive electrode plate 3 of a lithium-ion secondary battery 12, it is possible to obtain the lithium-ion secondary battery 12 having a high capacity and a high security. Consequently, the present invention makes it possible to provide: a positive electrode material that can attain a high capacity and a high security required for a battery of an electric automobile; and a lithium-ion secondary battery 12.

### INDUSTRIAL APPLICABILITY

The present invention can be used: for a positive electrode material of a lithium-ion secondary battery and the lithium-ion secondary battery and; in particular for a lithium-ion secondary battery of an electric automobile.

### LIST OF REFERENCE SIGNS

3 Positive electrode plate
4 Negative electrode plate
5 Separator
6 Positive electrode lead piece
7 Negative electrode lead piece
8 Airtight lid
9 Battery can
10 Packing
11 Insulating plate
12 Lithium-ion secondary battery

What is claimed is:

1. A positive electrode material for a lithium-ion secondary battery comprising a positive electrode active material represented by xLi₂MnO₃-(1-x)LiNiₐMn_{b}Co_{c}M_{d}O₂ (0.3≦x≦0.7, 0.33≦a≦0.5, 0≦b≦0.5, 0≦c≦0.33, 0.01≦d≦0.06), wherein M includes V or both of V and Mo.

2. The positive electrode material according to claim 1, wherein the concentrations of Li₂MnO₃ and LiNiₐMn_{b}Co_{c}M_{d}O₂ are uniform in the particles of the positive electrode active material.

3. The positive electrode material according to claim 1, wherein a ratio of V existing at a depth of 500 nm from a particle surface is in the range of 0.8 to 1.2 to a ratio of V existing at a depth of 50 nm from the particle surface.

4. A lithium-ion secondary battery having a positive electrode material according to claim 1.

5. A lithium-ion secondary battery having a positive electrode material according to claim 2.

6. A lithium-ion secondary battery having a positive electrode material according to claim 3.
